(19) United States
(12) Patent Application Publication
(10) Pub. No.: US 2007/0273311 A1
(43) Pub. Date: Nov. 29, 2007

(54) Electric Household Food Preparation Appliance Which Is Designed To Be On Standby And Reactive

(75) Inventors: Michel Guinet, Pau (FR); Jose Herada, Vienne (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 10/585,297

(22) PCT Filed: Dec. 23, 2004
(86) PCT No.: PCT/FR04/03372

§ 371 Date: Jul. 6, 2006

(30) Foreign Application Priority Data
Jan. 6, 2004 (FR) 0400058

(51) Int. Cl. H02P 7/00; H02P 25/14

(52) U.S. Cl. 318/245; 318/460; 318/476

(57) ABSTRACT

The invention relates to an electric household food preparation appliance comprising a control/command device consisting of: means for evaluating the load or resisting torque (C1, C2, C3) applied to the motor; and means for automatically switching the operation of the appliance from a first mode to a second mode when the load drops below a first predetermined threshold (SB), the operating speed of the appliance decreasing when the load drops from a value greater than the first threshold (SB) to a value lower than the first threshold (SB). According to the invention, the control/command device of the appliance comprises means for automatically switching the operation of the appliance from the second mode to the first mode when the aforementioned load rises above a second predetermined threshold (SH), the operating speed of the appliance increasing when the load rises from a value lower than the second threshold (SH) to a value greater than the second threshold (SH).

### TECHNICAL FIELD

The invention relates to the field of electric household appliances, and more particularly to the field of electric household appliances intended for the preparation of food. Among these appliances there are in particular mono- or multi-function food processors of all kinds, and for example mixers (also called blenders), beaters, meat-grinders, juice separators, centrifugal machines and other electric cutters.

The invention more particularly relates to an arrangement of the device for monitoring and control of the electric motor equipping such appliances. It is more specifically directed to management of the speed of this motor as a function of its load.

### PRIOR ART

In a general manner, food processors are equipped with one or several electric motors that can be of various types, and for example universal, operating with D.C. current, or brushless. These motors are frequently supplied so that they rotate at a variable speed, to actuate a rotary tool that depends on the type of appliance.

In operation, the motor is supplied to provide a sufficient torque to carry out the necessary operations. When the resistive torque applied to the motor decreases, due to the fact for example that the food to be ground or chopped indeed was, the speed of the motor increases according to the characteristic curve of the motor. This increase in no-load speed is particularly marked for certain types of motors such as universal motors.

This increase in speed inevitably results in an unnecessary electric consumption, and the generation of an acoustic noise. When the appliance is equipped with a speed adjusting device, the user can then modify the assigned speed applied to the motor. It can be understood that it is desirable to eliminate this intervention by the user to assure this adjustment automatically.

Solutions have already been proposed to take account of the phenomena of variation of resistive torque applied to the motor.

Thus, in the document U.S. Pat. No. 4,691,870, the appliance described comprises a control device that automatically ensures a stabilization of the speed of the motor when the load, or the resistive torque, applied to the motor fluctuates slightly. Compensation systems make it possible to maintain the speed of the motor at the fixed assigned level, despite torque variations. However, this system maintains a high speed level even when the load has disappeared, thus generating the disadvantages of consumption and noise already mentioned. This document discloses a traditional regulation in which the speed of operation of the appliance tends to remain constant when the load decreases or increases. The speed of operation of the appliance does not decrease or does not increase on a long term basis.

The document EP 0 480 309 describes another solution which was proposed to limit the acoustic noises generated in appliances of the food processor type. Such a device comprises means making it possible to limit the speed of the motor to a maximum speed of use. However, this speed is not adapted as a function of the load applied to the motor, and the acoustic noise thus remains high at a reduced load.

In addition, the document JP 11-225891 describes a mixer that stops mixing automatically as soon as the food has reached a sufficient level of grinding. This device thus comprises means to detect the state of the material in the mixing bowl, and stops the motor of the appliance when the degree of mixing is considered to be sufficient. This degree of mixing can be estimated in different ways, and in particular by the analysis of a light signal passing through the material contained in the bowl, or even by measurement of the current supplying the motor. A disadvantage of this type of device is that it is adapted only to individual operations, since the motor is stopped after each operation. It is thus necessary for the user to restart the motor by an action on the appliance.

It is thus considered that this type of device is not adapted for tasks in which the food is introduced into the appliance in several stages, and in a discontinuous way, for example when it is a question of grating vegetables or cheese.

A problem which the invention seeks to solve is that of excessive electric consumption, and the inopportune generation of acoustic noises when the appliance functions almost “empty”, i.e. with a very small load or zero load.

Another objective of the invention is to make it possible to link the performance of discontinuous operations, without requiring intervention by the user.

### SUMMARY OF THE INVENTION

The invention thus relates to an electric household appliance for preparation of food. In a known way, this appliance comprises an electric motor able to drive a rotary tool at a variable speed and a monitoring/control device provided to cause the motor to operate according to at least a first operating mode and a second operating mode.

This appliance also includes means to evaluate the load or the resistive torque applied to the motor, as well as means for automatically switching from the first operating mode to the second operating mode when said load passes below a first predetermined threshold, and when the load passes from a value higher than the first threshold with a value lower than the first threshold, the operating speed of the appliance decreases.

In accordance with the invention, this appliance is characterized in that the monitoring/control device also has means to automatically switch the operation of the appliance from the second operating mode to the first operating mode when the load again passes above a second predetermined threshold, and when the load passes from a value lower than the second threshold to a value higher than the second threshold, the speed of operation of the appliance increases.

In other words, the invention consists in ensuring a monitoring of the load applied to the motor. This not only makes it possible to automatically reduce the speed of the latter when it is no longer necessary to exert a high torque, but also to again increase the speed as soon as the presence of food to be treated is detected.

In other words, the system is able to be placed automatically “in standby” (second operating mode), by automatically reducing the speed in the case of an operation of the tool when empty, while remaining ready to provide a higher speed (first operating mode) when that again becomes necessary. This management is done in a completely automatic way without the user having to carry out any action.

The speed of the motor, and thus its electric consumption, is thus optimized. Also, one avoids an inopportune generation of acoustic noises in the phases where the motor turns while the appliance is empty.

Advantageously, when the load passes from a value higher than the first threshold to a value lower than the first threshold, the speed of operation of the appliance decreases by at least 5%; and when the load passes from a value lower than the second threshold to a value higher than the second threshold, the speed of operation of the appliance increases by at least 5%.

The first operating mode can be defined by a first reference speed and the second operating mode can be defined by a second reference speed.

The speed applied to the motor can be defined by an assigned speed, when the appliance comprises a speed sensor associated with a regulation device. The means for increasing or decreasing the speed can consist of a modification of the assigned speed of the motor.

The speed applied to the motor can also depend on the characteristic of the torque/speed curve of the motor, when the motor speed is not regulated. In this last case, the speed depends on the motor load. In particular, with universal motors, the supply voltage of the motor makes it possible to define the characteristic of the torque/speed curve of the motor. The means to increase or decrease the speed can consist of means to modify the supply voltage of the motor.

In practice, the threshold of resistive torque causing the reduction in speed can be identical, except for hysteresis, to the threshold from which the nominal speed of the motor is automatically restored. However, these two thresholds also can be different.

Advantageously in practice, these predetermined load thresholds, for the automatic reduction and/or increase of the speed of the motor, also can be variable, and can depend on the initial speed value. In other words, the threshold of resistive torque that generates placing in standby need not be the same according to whether the nominal speed is high or not.

This characteristic makes it possible to adapt to different types of operation, for example dedicated to the treatment of different types of food with the same appliance.

Similarly, it can also be advantageous for the value of the speed after reduction to be a function of the measured value of the load.

In other words, the lower the measured or estimated resistive torque, the more the speed of the motor will be reduced.

Advantageously in practice, the appliance can be arranged to additionally decrease the speed when the load remains below the threshold predetermined for this placing in standby, for a predetermined length of time. In other words, the speed can be further reduced, or even eliminated, when the standby state persists, signifying that the operations on food are ended.

In practice, the means to detect the load applied to the motor can be very varied. The torque can be thus measured by a force sensor provided for this purpose, or even by measurements of electric parameters specific to the motor, such as the current consumed by the motor or the voltage between its terminals. It is also possible to detect a load variation by a measurement of the difference between an assigned speed and a measured speed, or even by a measurement of the acoustic noise.

The load fluctuations are also a means of knowing that the tool is working. It is possible to take account of the load fluctuations in the estimate of the torque. Thus the estimated torque can be increased if the load fluctuates. In an equivalent way, a fluctuation of load can be taken into account by an increase of the torque threshold.

Advantageously the speed of the motor is reduced to a non-zero value when the load passes below the first predetermined threshold. This provision makes it possible to facilitate the detection of an increase in load on the tool above the second predetermined threshold. This provision also makes it possible to signal to the user that the appliance is in the standby state. Alternatively, if the motor no longer turns when the appliance is in the standby state, an indicating device could be considered, in particular an indicator light device.

Advantageously, the speed of the motor is reduced by at least 15% when the load passes below the first predetermined threshold. The reference speed is the speed of operation of the motor under the aforementioned load in the absence of the device according to the invention, and not the speed of the motor in the presence of a load higher than the first predetermined threshold. This provision makes it possible to obtain a significant reduction in the noise of the appliance.

Advantageously still, the speed of the motor is reduced by at least 30% when the load passes below the first predetermined threshold. This provision makes it possible to obtain an even greater reduction of the noise of the appliance.

The present invention is particularly advantageous in the case of a universal motor, because it makes it possible to avoid an excessive increase in the speed when the load applied has decreased substantially and the motor speed is not controlled.

### BRIEF DESCRIPTION OF THE FIGURES

The manner of carrying out the invention as well as the advantages that result therefrom will appear clearly from the description of the embodiment that follows and its variants, with the aid of the annexed figures, in which:

FIG. 1 is an overall perspective view of an example of a food processor.

FIG. 2 is a diagram illustrating a monitoring/control device of the appliance of FIG. 1.

FIG. 3 shows a set of waveforms illustrating the variation of an assigned speed, as a function of the load applied to the motor, for an appliance having a monitoring/control device as illustrated in FIG. 2.

FIG. 4 is a diagram illustrating an alternative of the control device for the appliance of FIG. 1.

FIG. 5 shows a set of waveforms illustrating the variation in speed as a function of the load applied to the motor, for an appliance having a monitoring/control device as illustrated in FIG. 4.

### MANNER OF CARRYING OUT THE INVENTION

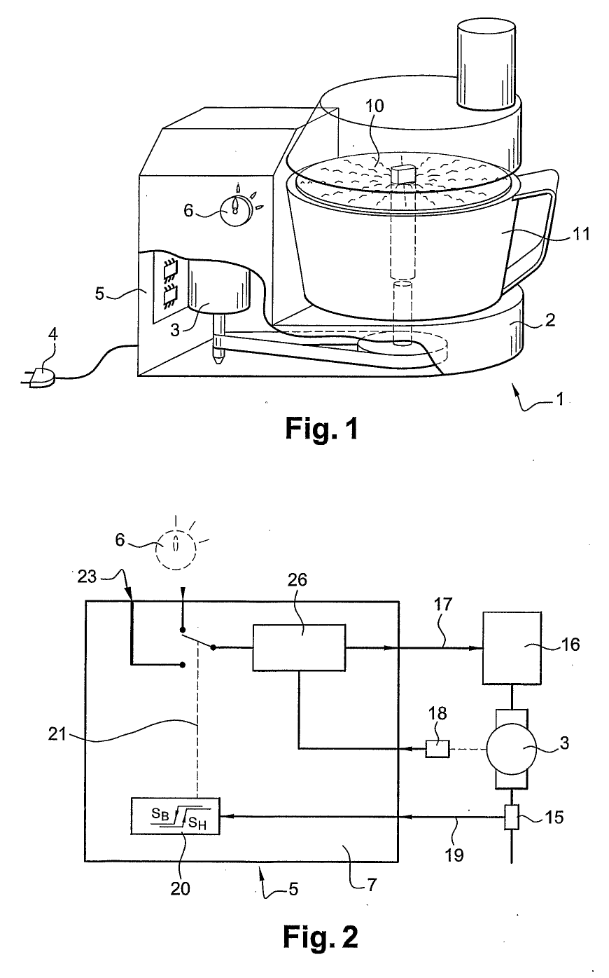

As already mentioned, the invention finds an application in multiple electric household appliances intended for the treatment of food, among which as illustrated on FIG. 1, a food processor (1). Such a food processor (1) comprises in a conventional manner a case (2) incorporating an electric motor (3) supplied from the voltage mains (4), or an autonomous (stand alone) power source. Its control is effectuated by means of an electronic or electromechanical monitoring/control device (5).

In the illustrated form, the food processor (1) is equipped with a speed selector (6) allowing the user to vary the speed of the motor (3). However, the invention also covers appliances in which the user cannot select the speed.

The electric motor (3) rotates a tool (10) which in the illustrated form is a disc carrying a cheese grater, disposed in the upper part of a bowl (11). The mechanical drive between the electric motor (3) and the tool (10) can be made in various ways, without affecting the principle of the invention.

According to one characteristic of the invention, the monitoring/control device (5) makes it possible to assure a variation of the speed applied to the electric motor (3), as a function of an estimate or a measurement of the resistive torque applied to this motor.

In the form illustrated in FIG. 2, the resistive torque can be estimated by measurement of the current flowing in the electric motor (3), via a sensor (15) of the shunt type, employing the Hall effect or other. However, as already mentioned, this resistive torque can be also evaluated in a different way, by measurements of the voltage between the terminals of the electric motor (3) or directly via a force sensor.

The electric motor (3) is supplied via a power circuit (16) that can for example be a control with phase commutation based on a triac or a thyristor or a diode, or a control of the chopper type integrating static switches based on IGBT or other power transistors or thyristors, associated in a conventional way with free wheeling diodes.

The speed of the motor is controlled by the delivery of control commands (17) to these static switches, the commands being developed at the level of an electronic card (7) of the monitoring/control device (5), illustrated on FIG. 2. The regulation of this speed as a function of the assigned speed applied can be made in various ways, and in particular by PID controllers.

The speed sensor (18) of the motor can be constituted by an optical fork that reacts to the passage of the teeth of a toothed wheel mounted on the axis of the electric motor (3), but of course any other type of speed sensor can be employed without departing from the framework of the invention. In certain cases, the food processor may not have a speed sensor, so that speed is not measured directly, but only estimated. The food processor also may not be provided with a speed control, the applied speed depending on the characteristic of the torque/speed curve of the motor and the load applied.

In accordance with the invention, the speed can adopt different values according to the estimated load. Thus, in the form illustrated in FIG. 2, the information of the current (19) flowing in the electric motor (3), representative of the resistive torque applied to the motor, is treated by a unit (20) analyzing said load, in order to deliver a signal (21) ordering the switching of the applied assigned value between two values.

In the illustrated form, the nominal assigned speed is indicated by the speed selector (6) accessible to the user. The other assigned speed (23) can be either preprogrammed at the level of the electronic card, or fixed with perhaps a possibility of adjustment or dynamic adaptation as a function of the nominal assigned speed.

In the illustrated form, the switching between the two assigned speeds corresponding to two operating modes, is done by comparing the estimated load with two thresholds, high and low (S_{B}, S_{H}), as a function of the direction of the load variation (19).

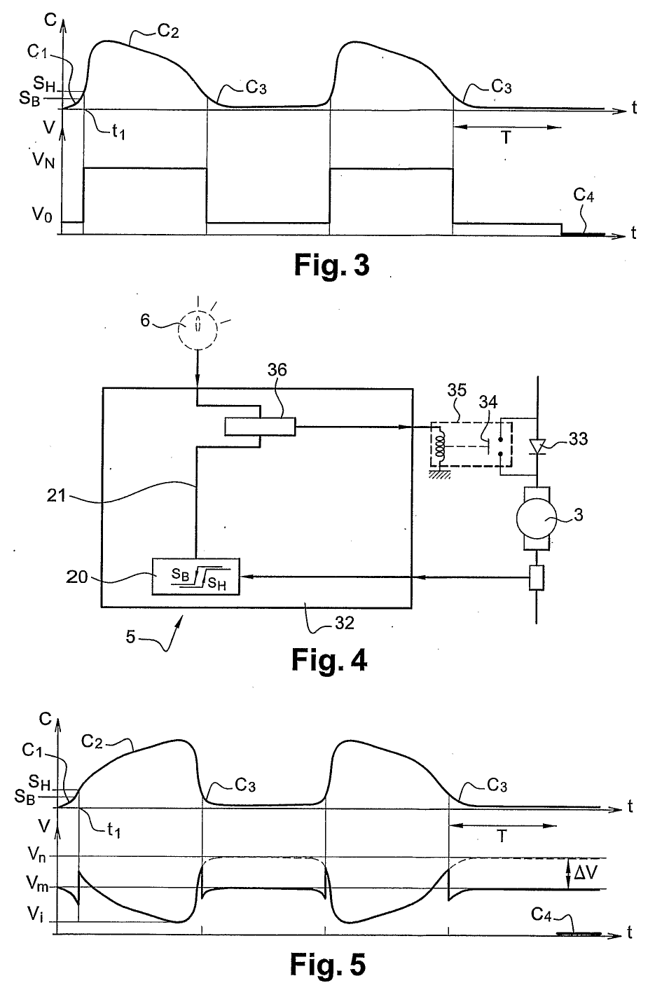

As illustrated in FIG. 3, after the user has started the appliance, and regulated the nominal rotation speed by means of the selector speed (6), the monitoring/control device (5) detects that the resistive torque (C₁) applied to the motor is low, and lower than the high threshold (S_{H}). Thus, the assigned speed applied to the motor is the low value (Vₒ). The appliance is in a “standby” mode, i.e., according to the second operating mode.

As soon as the user places a food of the type of a piece of cheese (t₁) in contact as a load, the resistive torque (C₂) applied to the motor increases, and the monitoring/control device (5) provokes a switching of the assigned speed to the nominal value (V_{N}), i.e., according to the first operating mode. The torque (C₂) provided by the motor increases to provide the mechanical force for cutting the piece of cheese.

When the entirety of the piece of cheese has been grated, the resistive torque (C₃) applied to the motor decreases, to pass below a low value (S_{B}). At this time, possibly after a delay, the monitoring/control device (5) provokes the passage of the assigned speed to the low value (Vₒ), corresponding to a standby mode, i.e., according to the second operating mode.

The speed can then increase when a new piece of cheese is introduced into the appliance.

As illustrated in FIG. 3, if the appliance is in a standby mode during a sufficiently long time (T), the speed controller (26) can cause an additional reduction, even a stopping of the motor.

It is also possible for the user to force an exit from the standby mode, without generating an increase in the resistive torque, but by acting on a control at his disposal at the level of the various selectors of the appliance.

The invention also covers more economical supply circuits for the motor, in which a diode (33) is disposed in series with the electric motor (3) such as for example a universal motor, as illustrated in FIG. 4. In this case, this diode (33) can be shorted-circuit by a contact (34) of a relay (35) controlled in a suitable way.

When the diode (33) is shorted-circuit (or shunted), the full voltage is applied to the motor (3), which turns then at its maximum speed for a given load.

When the contact (34) of the relay (35) is opened, the diode (33) is in series with the electric motor (3), so that the drop in voltage across its terminals decreases the voltage applied to the motor. The latter then turns at a lower speed for said given load.

The control of the relay (35) is carried out by a unit (36) of the electronic card (32) which combines information coming from the speed selector 6) (if it exists), and the signal (21) of comparison of the resistive torque with respect to the predetermined threshold, developed by the unit (20) of the monitoring/control device (5).

Thus it is possible, when the load applied to the tool has decreased because of the end of the treatment of the food, to avoid an excessive increase in the speed of an electric motor not controlled by a speed sensor.

As illustrated in FIG. 5, after the user has started the appliance, the monitoring/control device detects that the resistive torque (C₁) applied to the motor is low, and lower than the high threshold (S_{H}). In this way, the motor is supplied with a reduced voltage. The appliance is in a standby mode, according to the second operating mode.

As soon as the user puts a food of the type of a piece of cheese (t₁) in contact as a load, the resistive torque applied to the motor increases. The speed of the motor starts to decrease, owing to the fact that the motor is not controlled in speed. When the resistive torque reaches the high threshold (S_{H}), the monitoring/control device (5) causes the switching of the motor supply. The diode (33) is shunted and the motor (3) is supplied with full voltage. The speed of the motor increases, then decreases under the effect of the increase in the load due to the mechanical force for cutting the piece of cheese.

When the entirety of the piece of cheese has been grated, the resistive torque (C₃) applied to the motor decreases, to pass below a low value (S_{B}). At this moment, possibly after a delay, the monitoring/control device (5) provokes the switching of the motor supply towards the first operating mode. The diode (33) is in series with the motor (3). The motor is supplied with a reduced voltage. The appliance has entered the standby mode.

The motor can be supplied again with full voltage when a new piece of cheese is introduced into the appliance.

As illustrated in FIG. 5, the speed Vₘ attained in the absence of a load with the device according to the invention can be higher than the minimum speed V₁ attained under load. However, the speed Vₘ attained in the absence of a load with the device according to the invention is lower at the Vₙ speed reached in the absence of load without the device according to the invention. The variation in speed ΔV between the speed Vₘ and the speed Vₙ makes it possible to reduce the noise generated by the appliance rotating in the absence of a load.

In practice, a reduction of approximately 15% in the speed makes it possible to reduce the sound level by approximately 3 decibels. Thus, in a quantified way, the motor can pass from a no-load speed of 10500 revolutions per minute (rpm) to 8800 rpm, for a reduction in noise of 50%. An additional reduction of 15%, bringing thus the no-load speed to 70% of maximum speed makes it possible to further reduce the volume of the sound level.

Thus, the electric household appliance (1) for preparation of food, has an electric motor (3) able to actuate a rotary tool (10) at variable speed, a monitoring/control device (5) comprising means for causing the motor to operate according to at least a first operating mode and a second operating mode.

This appliance also includes means to evaluate the load or the resistive torque (C₁, C₂, C₃) applied to the motor, as well as means to automatically cause switching of the operation of the appliance from the first operating mode to the second operating mode when said load passes below a first predetermined threshold (S_{B}).

According to the invention, this appliance is characterized in that the monitoring/control device (5) also has means to automatically cause switching of the operation of the appliance from the second operating mode to the first operating mode when said load again passes above a second predetermined threshold (S_{H}).

Thus, when the appliance passes from the first operating mode called “active” to the second operating mode called standby, the operating speed decreases on a long term basis; and when the appliance passes from the second operating mode to the first operating mode, the speed of operation of the appliance increases on a long term basis.

The expression “decrease on a long term basis” referring to the operating speed means that if the load is stabilized below the first threshold (S_{B}), the speed reduction persists compared to a load higher than the first threshold (S_{B}).

The expression “increase on a long term basis” referring to the operating speed means that if the load is stabilized beyond the second threshold (S_{H}), the speed increase persists compared to a load lower than second threshold (S_{H}).

However, this reduction or this increase can intervene only locally. In other words, the no-load operating speed of the second mode can be higher than the operating speed for a load higher than the threshold (S_{B}) of the first mode.

Preferably, when the load passes from a value higher than the first threshold (S_{B}) to a value lower than the first threshold (S_{B}), the operating speed of the appliance decreases by at least 5%; and when the load passes from a value lower than second threshold (S_{H}) to a value higher than second threshold (S_{H}), the speed of operation of the appliance increases by at least 5%.

Of course, the estimate of the resistive torque applied to the motor can be done by combining the different parameters mentioned above, measurement of electric, mechanical, or acoustic parameters of the motor, and possibly their variation with time.

It results from the preceding that the appliance according to the invention presents multiple advantages, and in particular to reduce the acoustic noise generated by the appliance in the phases where it is not necessary to deliver substantial power.

Similarly, the electric consumption of the appliance is reduced in the phases of low mechanical consumption. One will note that the totality of these advantages is obtained in an automatic way, without requiring specific handling by the user.

Moreover, the management of these operating modes does not require the introduction of expensive electric or electronic components, in particular when the speed regulation is carried out by means of a microcontroller.

1. Electric household appliance for preparation of food (1), having an electric motor (3) able to drive a rotary tool (10) at a variable speed, a monitoring/control device (5) comprising means to cause the motor to operate according to at least a first operating mode and a second operating mode, means to evaluate the load or the resistive torque (C₁, C₂, C₃) applied to the motor, and means for automatically switching the operation of the appliance from the first operating mode to the second operating mode when said load passes below a first predetermined threshold (S_{B}), and in which, when the load passes from a value higher than the first threshold (S_{B}) to a value lower than the first threshold (S_{B}), the speed of operation of the appliance decreases, characterized in that the monitoring/control device (5) also comprises means to automatically switch the operation of the appliance from the second operating mode to the first operating mode when said load again passes above a second predetermined threshold (S_{H}), and in that when the load passes from a value lower than the second threshold (S_{H}) to a value higher than the second threshold (S_{H}), the speed of operation of the appliance increases.

2. Appliance according to claim 1, characterized in that when the load passes from a value higher than the first threshold (S_{B}) to a value lower than the first threshold (S_{B}), the speed of operation of the appliance decreases by at least 5%.

3. Appliance according to claim 1, characterized in that when the load passes from a value lower than the second threshold (S_{H}) to a value higher than the second threshold (S_{H}), the speed of operation of the appliance increases by at least 5%.

4. Appliance according to claim 1, characterized in that the predetermined load thresholds for the automatic reduction (S_{B}) and/or increase (S_{H}) of the speed of the motor, depend on the initial speed value.

5. Appliance according to claim 1, characterized in that the predetermined thresholds (S_{B}, S_{H}) are identical for the reduction and automatic increase of the speed.

6. Appliance according to claim 1, characterized in that it has means to additionally decrease the speed when the load (C₃) remains below the predetermined threshold for the reduction of the speed for a predetermined length of time.

7. Appliance according to claim 1, characterized in that the assigned speed after reduction is a function of the measured value of the load.

8. Appliance according to claim 1, characterized in that the means to detect the load applied to the motor include means (15) to measure the electrical current consumed by the motor, or the voltage at the terminals of the motor (3).

9. Appliance according to claim 1, characterized in that the means to detect the load applicable to the motor include means for measurement of the acoustic noise generated by the appliance.

10. Appliance according to claim 1, characterized in that the speed of the motor is reduced to a non-zero value when the load passes below the first predetermined threshold (S_{B}).

11. Appliance according to claim 1, characterized in that the speed of the motor is reduced by at least 15% when the load passes below the first predetermined threshold (S_{B}).

12. Appliance according to claim 1, characterized in that the speed of the motor is reduced by at least 30% when the load passes below the first predetermined threshold (S_{B}).

13. Appliance according to claim 1, characterized in that the electric motor (3) is a universal motor.
